(19) United States
(12) Patent Application Publication
(10) Pub. No.: US 2009/0186157 A1
(43) Pub. Date: Jul. 23, 2009

(54) Method for at least selectively removing a first layer from an engine component

(75) Inventors: Anton Albrecht, Bad Koetzting (DE); Max Niegl, Muenchen (DE); Juergen Olfe, Volkse (DE); Georgios Paronis, Augsburg (DE); Michael Sachon, Schwabenhausen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/321,302

(22) Filed: Jan. 16, 2009

(30) Foreign Application Priority Data
Jan. 19, 2008 (DE) 10 2008 005 168.3

(51) Int. Cl. B05D 3/10; C23F 1/00

(52) U.S. Cl. 427/307; 216/95; 216/52

(57) ABSTRACT

A method for selectively removing a first layer from an engine component including the first layer, a base material and a second layer forming a bond connecting the first layer to the base material is provided. The method includes applying a salt melt to at least one section of the engine component including at least one portion of the second layer so the bond formed by the second layer between the base material and the first layer is at least weakened.

Priority is claimed to German Application Serial No. DE 10 2008 005 168.3, filed Jan. 19, 2008, the entire disclosure of which is hereby incorporated by reference herein.

The present invention relates to a method for selectively removing a first layer from an engine component, respectively to a method for repairing or reconditioning engine components, as well as to a device provided for implementing such a method.

### BACKGROUND

Engine components are often provided with diverse layers. It is known, for example, for heat-insulating layers, respectively ceramic cover layers, to be provided on engine components. Such heat-insulating layers can be composed of zirconium oxide, for example. These types of heat-insulating layers, respectively cover layers are bonded via what are generally referred to as adhesion layers, respectively TGO layers (thermal growing oxide), to the base material. Adhesion layers of this kind can be Pt—Al, Al, or MCrAlY layers, for example. In the course of repair or reconditioning work, it is often necessary to remove layers, in particular heat-insulating or cover layers, from engine components. This is frequently the case prior to repair, respectively recoating processes. It is at least known to the applicant that heat-insulating layers are generally removed exclusively by mechanical methods, such as by high-pressure water or Al₂0₃ jet blasting, for example. Moreover, it is also known to the applicant—at least internally—that highly concentrated KOH alkaline solution is used at high temperatures and pressures to remove coatings.

To some degree, the purely mechanical methods have turned out to be not very selective, so that there is always the danger of an uneven ablation and of damage to the component, respectively to the adhesion layer. Under certain circumstances, KOH alkaline solution is only partially effective when working with highly adhesive layers, so that extensive mechanical reworking is often required. It is often the case in the methods used heretofore that the adhesion layer disposed underneath the heat-insulating layer, respectively the cover layer, or even the base material is attacked, with the result that the component can no longer be repaired or can only be repaired at considerable expense. In particular, in the known methods, the situation can arise where the dimensional accuracy of the parts is affected, respectively where the throughput of air through the cooling-air channels—to the extent that such channels are provided—is degraded. Recoating these new parts, respectively parts having a useful life, does not necessarily make up for the deficiencies described above, so that these parts would have to be classified as scrap. Affected components can include, inter alia, turbine blades and guide vanes made of nickel materials. The parts are often coated with a ceramic EB-PVD heat-insulating layer and an underlying Pt—Al adhesion layer. Moreover, an alitization may have been carried out in the inner region.

### SUMMARY OF THE INVENTION

Against this background, an object of the present invention is to devise a method for repairing or reconditioning, respectively for removing coatings from gas turbine components that is characterized by operational reliability and is simple to implement.

The objective is achieved in accordance with emobodiments of the present invention.

Thus, in particular, a method for selectively removing a first layer from an engine component, respectively for stripping an engine component, is devised by the present invention. In an advantageous embodiment, the engine component is a blade, such as a turbine blade or a compressor blade. It may be provided for the engine component, respectively the blade, to have a system of internal channels, which is used during operation, for example, for cooling or air cooling. The engine component has a base material upon which at least two layers are provided or are deposited. One of these at least two layers is referred to as first layer, and another one of these at least two layers is referred to as second layer. Between the base material and the first layer, at least one second layer, respectively the second layer is provided.

One especially preferred embodiment provides for the second layer to be a thermally grown oxide layer (TGO layer). The second layer may be an Al₂0₃ layer, for example. In particular, the second layer is an adhesion layer. The first layer may be a heat-insulating layer, for example. It may be provided in this context for the second layer to be an adhesion layer for this heat-insulating layer and to be of the aforementioned type, for example.

In addition to the first and second layer, one further layer may also be provided. The additional layer, which is referred to as third layer, may be a diffusion layer, for example. The third layer may be a Pt—Al layer, an Al layer, or an MCrAIY layer, for example.

It may be provided for the second layer to be disposed between the first layer and the third layer. For example, it may be provided for the second layer to adjoin the first layer and/or the third layer, in particular, directly in each case.

The method according to the present invention provides for a salt melt to be applied in such a way that at least one section of the engine component, which has at least one portion of the second layer, is positioned in the salt melt, the bond effected by the second layer between the base material and the first layer being thereby at least weakened, respectively attacked.

It is emphasized once again in this connection that it is not required that the second layer bond the base material directly to the first layer; rather other layers may also be disposed therebetween. It may also be provided in accordance with one preferred specific embodiment, however, for the second layer to be directly configured between the first layer and the base material.

One preferred further refinement provides for the first layer to be removed, respectively stripped exclusively in that the bond effected by the second layer between the base material and the first layer is attacked, respectively broken down chemically by the salt melt. It is also noted in this connection that other layers may be provided between the base material and the first layer.

In accordance with one alternative embodiment, following application of the salt melt to at least one layer of the two layers, which include the first layer and the second layer, mechanical action is carried out and, in fact, in particular in that the first layer is at least partially removed. This mechanical action may be a blasting process, such as, in particular, high-pressure water jet blasting. It may also be provided for this mechanical action to be a chemically accelerated vibratory grinding or a vibratory grinding or the like.

In one preferred embodiment, the first layer is a heat-insulating layer. The first layer may be a heat-insulating layer of zirconium oxide, for example.

The salt melt may be a KOH melt or an NaOH melt, for example, or a mixture of a KOH melt and an NaOH melt. The temperature that the melt is brought to may be within the range of 300° to 800°, for example, within the region of 500°, within the region of 700°, or within the region of 400°.

It may be provided for the engine component to be treated by the melt in a plurality of cycles, such as in three cycles of 30 min. each. It may also be provided for the engine components to be subsequently quenched, such as quenched in water, for example. It may also be provided for this to be followed by a high-pressure water blasting, to facilitate removal of the first layer.

The treatment times in the melt may be within the range of 5 to 1000 min., for example; preferably within the range of between 30 and 300 min.; preferably between 30 and 200 min., for example 40 min., 80 min., 180 min., or 60 min. It is especially preferred that the engine component remain in the salt melt for a time period of between 30 min. and 120 min.

It may be provided for new parts, thus, for example new blades, such as turbine blades or guide vanes made of nickel materials, to play an integral role in the method. The first layer may be an EB-PVD layer, for example. In particular, the first layer is a heat-insulating layer. At least preferred specific embodiments of the method according to the present invention make it possible for a heat-insulating layer to be selectively removed by the combination of a salt melt and water jet blasting without the base material or a diffusion layer deposited thereon or a layer composed of a build-up and diffusion layer, such as a Pt—Al layer, being damaged.

It is especially provided for the method according to the present invention to be based on the chemical reaction of the alkaline decomposition.

As mentioned, the first layer is preferably a heat-insulating layer. It may be provided for the heat-insulating layer to be bonded via a thermally grown aluminum oxide layer (TGO) to the base material. This TGO may be attacked by salt melts (for example, a KOH melt), with the result that the heat-insulating layer peels away from the component in large pieces. It may be provided for the temperature, to which the melt is brought, to be greater than the melting temperature of the salt, such as KOH or NaOH. For example, the salt melt may have a temperature of 400° or of approximately 400°.

In one advantageous embodiment, the component itself is not at all attacked, but is completely stripped. The method may be carried out simultaneously for a plurality of parts and is simple, fast and, therefore, also cost-effective.

It is provided, in particular, that the method make it possible for a heat-insulating layer to be completely removed from an adhesion layer and from the base material without any attack on the adhesion layer or the base material occurring in the process.

One advantageous embodiment provides for the first layer to be an EB-PVD layer. It may be provided for the first layer, respectively the EB-PVD layer attacked by the salt melt, respectively the EB-PVD layer, whose adhesion properties are thereby reduced, to be removed by water jet blasting. The water jet parameters may be set to be less rigorous, for example, so that a Pt—Al attack by the water jet does not occur or occurs to a minor degree.

It may be provided for the components, respectively turbine components, respectively blades to be processed in a plurality of cycles in the salt melt. A cycle of this kind may be within the range of 10 to 16 min., for example.

As salt melts, alkaline, acid and/or neutral salt melts, such as KOH, NaOH or KHSO₄ may be used, for example. The temperatures of the salt melts—particularly for the aforementioned salts, respectively salt melts—may be within the range of 300° C. to 700° C. In one embodiment to be especially preferred, the salts Durferrit RS DS or Durferrit RS 700 are used, which are from the firm Durferrit Benzima, or pure salts from other manufacturers that were produced in accordance with suitable mixtures to adjust the melting point of the salt melt.

In an especially advantageous embodiment, the turbine components, respectively blades have cooling-air channels in the interior thereof.

It may be provided for the components, respectively turbine components, respectively blades to be rinsed with, respectively in water, after they have been removed from the salt melt and/or after they had been acted upon mechanically following processing of the salt melt, in order to remove the first layer. It may be provided for the components, respectively turbine components, respectively blades to be rinsed using devices which render possible a forced rinsing (in particular interior flooding) of the cooling-air channels—to the extent that such channels are provided.

One advantageous embodiment provides for the parts, respectively components, respectively blades, respectively turbine components to undergo an intermediate treatment in liquid nitrogen, which effects a thermal shock and thus an embrittlement of the heat-insulating layer.

It may be provided for the components, respectively the engine components, respectively the blades to be neutralized in an inorganic or organic acid, such as HCL or HNO₃, for example, and, in fact, in particular, following removal thereof from the salt melt and/or following mechanical treatment, respectively blasting thereof. Following this neutralization, it may also be provided for the components to be rinsed using devices which render possible a forced rinsing (interior flooding) of the cooling-air channels—to the extent that they are provided, so that molten salt residues are neutralized in the cooling-air channels.

To the extent that the water-jet blasting method, respectively a corresponding mechanical treatment is provided, this may be carried out prior to, in-between or following the individual treatment cycles in which a salt melt is used, provided that a plurality of treatment cycles using a salt melt are provided.

In place of an aftertreatment using water jet blasting, a different mechanical postprocessing process may also be employed, such as Al₂0₃ blasting, plastic blasting or vibratory grinding.

As mentioned, the first layer may be an EB-PVD heat-insulating layer; instead of an EB-PVD heat-insulating layer, thermally spray-coated heat-insulating layers, respectively ceramic layers may also be removed by employing the method according to the present invention. The components, respectively engine components, respectively blades may be encapsulated by a cover, so that, for example, the blade root or the shroud bands—to the extent that they are provided—are protected while in the salt melt.

The method according to the present invention, respectively the refinement of the same render possible numerous advantages, which are mentioned exemplarily in the following, it being noted, however, that these advantages do not necessarily have to be provided.

One advantage is derived, for example, in that a complete removal of the first layer, respectively of the EB-PVD layer is made possible, especially at difficult-to-access locations, such as at cooling-air bores. A further advantage is derived in that the processing of blades having complex geometries, such as guide vanes, for example, which are not optimally suited for application of a water jet blasting process alone, may be carried out. Yet another advantage resides in that shorter treatment cycles may be carried out in the salt melt, since the attacked, respectively residual ceramic cover layer is removed by the mechanical reworking. Another benefit derived is that the method may be used for repairing, reconditioning, as well as for new parts manufacturing. Another advantage resides in that the method is suited for selectively removing only the heat-insulating layer.

Yet another advantage is that the method is suited for removing the heat-insulating layer in the salt melt, instead of using high-pressure water jet blasting or A1₂0₃ and subsequently chemically removing the adhesion layer (Pt—Al, Al or MCrAlY).

Another advantage is that the method is suited for removing or damaging the heat-insulating layer only by employing high-pressure water jet blasting and subsequently chemically removing the adhesion layer (for example, Pt—Al, Al or MCrAlY).

Another advantage is that the method is suited for removing the heat-insulating layer only by employing high-pressure water jet blasting, without damaging the adhesion layer.

Another advantage resides in that the treatment times in the salt melt are able to be kept as short as possible, so that there is no attack on the Pt—Al adhesion layer or any other comparable layer or on the interior coating—in the case that one is provided.

One advantageous embodiment provides that the section of the engine component which includes at least one portion of the second layer be positioned in the salt melt for a time period of at least 5 min., preferably of at least 10 min., especially of at least 15 min., especially of at least 20 min., especially of at least 30 min., especially of at least 40 min., especially of at least 50 min., and especially of at least 60 min.

One especially advantageous embodiment provides for a new first layer to be deposited following removal of the first layer and, if indicated, further repair work. Thus, the first layer is quasi replaced in an advantageous embodiment. Accordingly, the method according to the present invention may also be described as a method for repairing or manufacturing engine components, such as blades, when such a replacement process is provided.

In one advantageous embodiment, the method is carried out by a device which includes a tank for accommodating the engine component and the salt melt. It may be provided in this context for the tank to be charged with the salt in a solid state, and for it to be likewise loaded with the engine component or a plurality of engine components. It may then be subsequently provided for the salt to be heated to form a melt.

It is also preferred that the salt melt be cooled prior to removal of the engine component following treatment with the salt melt, respectively, that it be ensured that the salt melt has solidified before the engine component is removed.

One advantageous embodiment provides for the method to be carried out in a fully automatic installation system. This may be a fully automatic installation which does not allow the operator of the installation to access the process vessel, also referred to as a tank. In one advantageous embodiment, the installation may be conceived in such a way that the components are placed into and removed from the devices exclusively at room temperature, thereby ruling out any potential operator contact with the melt. For example, the device may be loaded in the cold state, charged with salt, and subsequently heated together with the component, respectively the engine component, and the salt, so that the salt becomes molten. Once the process is concluded, it may be provided, prior to being opened by the operator, for the device, respectively the melt to be cooled again, and for the component, respectively the engine component, to be removed. The device is preferably conceived in such a way that the salt melt and the component are separated at the end of the process, so that the melt is solidified, for the most part separately from the component.

It may be provided for the safe operation of the installation to be ensured by a complete separation of the operator and the salt melt. As a result, the installation may have a simple and cost-effective design. For the heating process, inexpensive standard ovens may be used, for example.

### BRIEF DESCRIPTION OF THE DRAWING

An exemplary embodiment of the present invention is clarified in greater detail below with reference to the enclosed figure:

FIG. 1 shows an exemplary device for implementing an exemplary method according to the present invention, including the steps indicated thereon and various states of the device.

### DETAILED DESCRIPTION

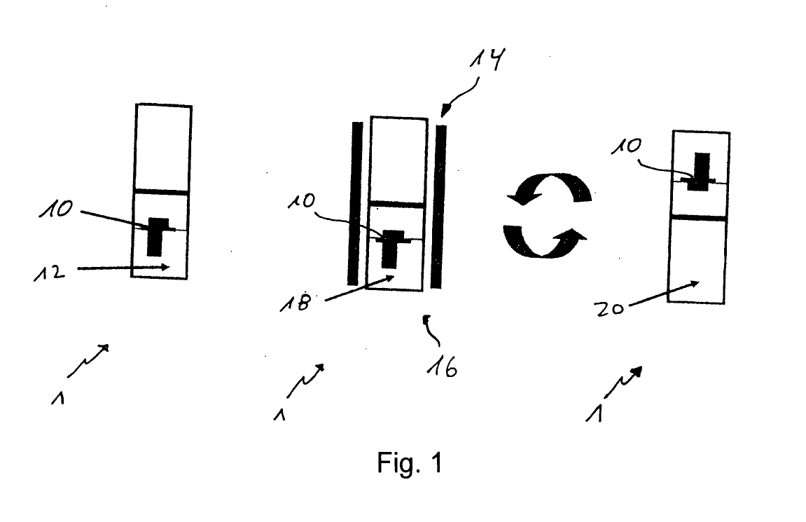

The illustration to the left in FIG. 1 shows a component 10, such as an engine component, in particular a blade, as well as salt and/or granular material 12 in the solid state. In this step, installation 1 is loaded under cold conditions.

The salt is subsequently heated to a temperature greater than that of the (salt) melt. This takes place in oven 14. This is carried out until the salt becomes molten, respectively is available as (salt) melt 18. This process takes place in closed tank 16, tank 16 optionally being filled with protective gas. The melt is subsequently separated from the engine component. The salt, respectively the melt is cooled until the salt becomes solid (solid salt 20). The engine component is subsequently removed.

### LIST OF REFERENCE NUMERALS

1 installation
10 component, respectively engine component, respectively blade
12 salt, respectively granular material
14 oven
16 tank
18 salt in the (salt) melt state
20 salt in the solid state

What is claimed is:

1. A method for selectively removing a first layer from an engine component including the first layer, a base material and a second layer forming a bond connecting the first layer to the base material, the method comprising the step of:
applying a salt melt to at least one section of the engine component including at least one portion of the second layer so the bond formed by the second layer between the base material and the first layer is at least weakened.

2. The method as recited in claim 1 further comprising the step of mechanically removing at least a portion of the first layer after the bond formed by the second layer between the base material and the first layer is at least weakened.

3. The method as recited in claim 2 wherein the mechanically removing step is performed by a high-pressure water jet blasting.

4. The method as recited in claim 1 wherein the bond is attacked and broken down chemically by the salt melt and the first layer is removed.

5. The method as recited in claim 1 wherein the first layer is a heat-insulating layer of zirconium oxide.

6. The method as recited in claim 1 wherein the second layer is a thermally grown oxide layer (TGO layer).

7. The method as recited in claim 1 wherein the engine component further includes a third layer.

8. The method as recited in claim 7 wherein the third layer is a diffusion layer.

9. The method as recited in either claim 7 wherein the third layer is a layer from a group of layers that includes a Pt—Al layer, an Al layer and an MCrAlY layer.

10. The method as recited in claim 7 wherein the second layer is between the first layer and the third layer.

11. The method as recited in claim 1 wherein the second layer directly adjoins the first layer.

12. The method as recited in claim 1 wherein the at least one section of the engine component including at least one portion of the second layer is positioned in the salt melt for a time period of at least five minutes.

13. The method as recited in claim 1 wherein the salt melt is a KOH melt.

14. The method as recited in claim 1 further comprising the steps of removing the first layer from the engine component and depositing a new layer on the engine component.

15. The method as recited as recited in claim 1 wherein the step of applying the salt melt to at least one section of the engine component is performed by a device which includes a tank for accommodating the engine component and the salt melt.

16. The method as recited in claim 15 wherein the step of applying the salt melt to at least one section of the engine component is performed by the steps of:
providing salt in the tank;
introducing the engine component into the tank; and
heating the salt from a solid state of aggregation to form the salt melt after the engine component is introduced into the tank.

17. The method as recited in claim 16 wherein the step of applying the salt melt to at least one section of the engine component further includes the steps of:
closing the tank after the engine component is introduced into the tank;
leaving the engine component in the salt melt for a predetermined time period; and
removing the engine component from the tank after the salt melt cools.
